(19) United States
(12) Patent Application Publication
(10) Pub. No.: US 2013/0060661 A1
(43) Pub. Date: Mar. 7, 2013

(54) MANAGING ACCESS TO DIGITAL CONTENT ITEMS

(71) Applicants: Eliza C. Block, San Francisco, CA (US); Marcel Van Os, San Francisco, CA (US); E. Caroline F. Cranfill, San Francisco, CA (US); Alan C. Cannistraro, San Francisco, CA (US); William M. Bachman, San Jose, CA (US); Timothy B. Martin, Sunnyvale, CA (US)

(72) Inventors: Eliza C. Block, San Francisco, CA (US); Marcel Van Os, San Francisco, CA (US); E. Caroline F. Cranfill, San Francisco, CA (US); Alan C. Cannistraro, San Francisco, CA (US); William M. Bachman, San Jose, CA (US); Timothy B. Martin, Sunnyvale, CA (US)

(73) Assignee: APPLE INC., Cupertino, CA (US)

(21) Appl. No.: 13/226,285

(22) Filed: Sep. 6, 2011

(51) Int. Cl. G06F 21/00; G06F 15/16; G06Q 30/00; G06F 7/04

(52) U.S. Cl. 705/26.44; 726/28

(57) ABSTRACT

Techniques are provided for managing access to a digital content item (such as an ebook, music, movie, software application) to be transferred from one user to another. The transferor is prevented from accessing the digital content item after the transfer occurs. The entity that sold the digital content item to the transferor enforces the access rights to the digital content item by storing data that establishes which user currently has access to the digital content item. After the change in access rights, only the transferee is allowed access to the digital content item. As part of the change in access rights, the transferee may pay to obtain access to the digital content item. A portion of the proceeds of the “resale” may be paid to the creator or publisher of the digital content item and/or the entity that originally sold the digital content item to the original owner.

### RELATED APPLICATION

This application is related to U.S. patent application Ser. No. ______ [Docket # P10251US2; 60108-0242], filed on the same day herewith, the contents of which are incorporated by reference as if fully set forth herein.

### FIELD OF THE INVENTION

The present invention relates to managing access to digital content items among end-users and preventing a transferor from accessing a digital content item after authorized access to the digital content item has been transferred to another.

### BACKGROUND

After a seller sells and delivers a physical item to a purchaser, the seller is typically no longer involved in further disposition of the physical item. Similarly, once an instance of a digital content item has been purchased by and distributed to an end-user, the seller of the digital content item is usually no longer involved with respect further transfers of that same instance of the digital content item to other users.

For example, a user may purchase a digital book from an online digital book retailer. The online digital book retailer sends the digital book over a network to a device of the user. Once the transfer of the digital book is complete, the online digital book retailer is no longer involved in any further transfers of that instance of the digital book. In fact, the user is often contractually obligated to refrain from transferring that instance of the digital book to devices of any other user. In some situations, a user is allowed to transfer a digital item (such as a movie) from one device of the user to another device of the user. In a subset of these situations, a user is further restricted in that the digital item can only be on one of the user's registered devices at any one time. Mechanisms are in place to ensure that this restriction is followed. Digital Rights Management (DRM) mechanisms are often employed to prevent many digital works, such as a digital books, digital music, and digital video, from being shared among end-users.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY

Techniques are provided for allowing authorized access to (or ownership of) a digital content item to be transferred from one user to another. A first user purchases a digital content item, such as a digital book, from an online store. The first user later decides to sell the digital content item to a second user. The first user and/or the second user notify the online store of this arrangement. The online store determines whether one or more criteria are satisfied in order to allow the transfer in ownership to take place. If the one or more criteria are satisfied, then the online store stores data that reflects the transaction and updates authorization data that authorizes the second user to access the digital content item and prevents the first user from accessing the digital content item. Alternatively, instead of a third party determining whether one or more criteria are satisfied, the first (or second) user's device makes the determination and may be responsible for preventing the first user's device from further consuming the digital content item. In some embodiments, the online store and/or the publisher of the digital content item may receive a portion of the proceeds of the transfer.

### BRIEF DESCRIPTION OF THE DRAWINGS

In the drawings:

FIG. 1 is a block diagram that depicts a set of relationships among entities involved in the transfer of authorized access to digital content items, according to an embodiment of the invention;

FIG. 2 is a block diagram that depicts computing entities that correspond to some of the entities in FIG. 1;

FIG. 3 is a flow diagram that depicts a process for managing access to a digital content item, according to an embodiment of the invention; and

FIG. 4 is a block diagram that illustrates a computer system 300 upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques are provided for managing access to digital content items. In particular, various techniques are described herein to enable an authorized transfer of a digital content item from a current owner of a digital content item (the “transferor”) to a new owner of the digital content item (the “transferee”). As used herein, a “digital content item” is any item that can be stored in a digital format, including but not limited to an “e-book,” music, movie, game, software application, ringtone, TV show, or audio book.

In one embodiment, a transferor of a digital content item is prevented from accessing the digital content item after the transfer occurs. The entity that sold the digital content item to the transferor may enforce the access restrictions that govern the digital content item by storing data that establishes which user currently is authorized to access the digital content item. After the change in authorized access, only the transferee is allowed access to the digital content item. As part of the change in authorized access, the transferee may pay to obtain access to the digital content item. A portion of the proceeds of the “resale” may be paid to the creator of the digital content item, to one or more of:
the publisher of the digital content item,
the entity that originally sold the digital content item to the transferor,
an entity that allows the transfer in ownership, and
the transferor.

The following description includes the phrases “authorized access to”, “authorization to access,” and “authorized to access” a digital content item. Such phrases are used interchangeably with phrases “ownership of,” “owns,” and “owner of” a digital content item. In other words, a user that is “authorized to access” a digital content item is referred to herein as the “owner” of the digital content item, regardless of whether the terms of the agreement by which the user acquires access characterize the user as an actual owner.

### Functional Overview

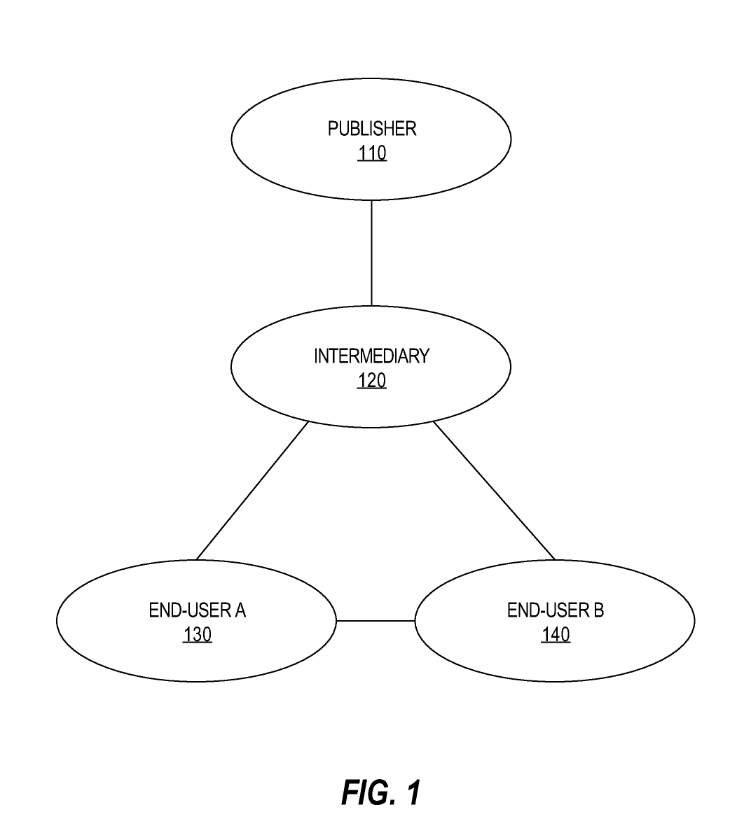

FIG. 1 is a block diagram that depicts a set of relationships among entities involved in the transfer of authorized access to digital content items, according to an embodiment of the invention. FIG. 1 depicts four separate entities or actors: publisher 110, intermediary 120, end-user 130, and end-user 140. Each line or edge connecting two entities indicates a relationship between the respective entities. Thus, publisher 110 provides digital content items to intermediary 120. Intermediary 120 provides digital content items to many end-users, including end-user 130. End-user 130 “provides” one or more digital content items (originally received from intermediary 120) to end-user 140.

In the embodiment illustrated in FIG. 1, intermediary 120 maintains information about which users have authorized access to which items. Consequently, after end-user 130 transfers authorized access to a digital content item to end-user 140, Intermediary 120 updates its ownership records to indicate that end-user 130 ceases to own the digital content item, and that end-user 140 is the new owner of the digital content item.

For purposes of simplicity, only one publisher and only two end-users are depicted in FIG. 1. However, many different publishers may provide digital content items to intermediary 120. Also, intermediary 120 may provide digital content items to many end-users. Furthermore, each end-user can enable the transfer of authorized access of many digital content items to many other end-users.

### The Publisher

Publisher 110 may or may not be the creator of one or more digital content items consumed by end-user 130. For example, publisher 110 may be a solo artist that creates one or more music tracks, an author that writes a novel, or a movie studio that creates a motion picture. As another example, publisher 110 is an entity that contracts with one or more creators of digital content items and that is responsible for distributing the digital content items to retailers (such as intermediary 120) that sell the digital content items to end-users.

In an embodiment, publisher 110 and intermediary 120 are the same entity. For example, publisher 110 distributes (e.g., sells) digital content items directly to end-users (e.g., end-user 130) for consumption.

### End-User Devices

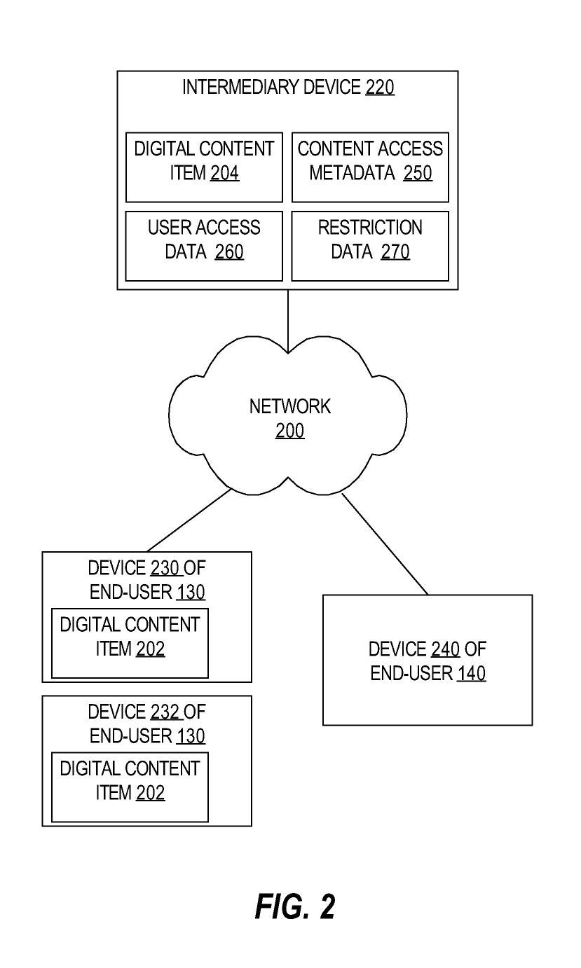

FIG. 2 is a block diagram that depicts computing entities that correspond to some of the entities in FIG. 1. Specifically, intermediary device 220 corresponds to intermediary 120, devices 230 and 232 belong to end-user 130, and device 240 belongs to end-user 140. While FIG. 2 illustrates a scenario in which intermediary 120 has one device 220, end-user 130 has two devices, and end-user 140 has one device, the entities in FIG. 1 are not limited to any particular number of computing devices.

For example, intermediary 120 may operate many computing devices. Similarly, end-users 130 and 140 may each operate any number of computing devices that are configured to receive and “consume” digital content items from intermediary 120 and/or to transmit digital content items to other end-users.

Non-limiting examples of devices 230, 232 and 240 include desktop computers, laptop computers, smart phones, tablet computers, and other handheld computing devices.

### Inter-Device Communications

Communication between intermediary device 220 and user devices 230, 232 and 240 is made possible via network 200. Network 200 may be implemented by any medium or mechanism that provides for the exchange of data between various computing devices. Examples of such a network include, without limitation, a network such as a Local Area Network (LAN), Wide Area Network (WAN), Ethernet or the Internet, or one or more terrestrial, satellite, or wireless links. The network may include a combination of networks such as those described. The network may transmit data according to Transmission Control Protocol (TCP), User Datagram Protocol (UDP), and/or Internet Protocol (IP). User A device 230 may be communicatively coupled to user B device 240 via network 200 and/or via peer-to-peer communication, described hereinafter.

### Digital Content Item Consumption

A user (or device operated by the user) is said to “consume” a digital content item when the user uses the digital content item for its intended purpose. The actual operations that are performed by a device to “consume” a digital content item vary based on the nature of the digital content item. For example, a user consumes a digital book when the user reads the digital book on a device operated by the user. As another example, a user consumes a digital song or music track the by playing the song or music track. As another example, a user consumes a software application when the user causes the software application to execute on a device operated by the user.

### Content Access Metadata

In the embodiment illustrated in FIG. 2, intermediary device 220 maintains content access metadata 250. Content access metadata 250 generally represents data that indicates which entity or entities are currently authorized to access digital content items. The nature of the entities that are currently authorized to access a digital content item may vary from implementation to implementation. For example, access may be authorized on a per-user basis, per account basis, and/or per device basis. Thus, content access metadata 250 for may indicate the current owner of digital content items 202 and 204 to be:
end-user 130,
an account of end-user 130, and/or
user device 230.

For purposes of illustration, end-user 130 is referred to hereinafter as “Jeff” and end-user 140 is referred to hereinafter as “Sally.” Unless otherwise stated, Jeff is the end-user that initially purchased (or otherwise received) digital content items 202 and 204 from intermediary 120 and, thus, initially owns and has authorized access to the digital content items 202 and 204.

According to one embodiment, content access metadata of digital content item 204 indicates:
(1) when the digital content item was originally purchased by an end-user (e.g., Jeff);
(2) a user identifier that uniquely identifies the end-user or an account (e.g., iTunes account) of the end-user;
(3) a price (e.g., $1.99) at which the digital content item was purchased or resold; and/or
(4) a device identifier that identifies one or more computing devices of the current owner of the digital content item.

Content access metadata 250 may further indicate when any transfer of authorized access to another end-user (e.g., Sally) occurs. Additionally, if there were multiple previous owners, content access metadata 250 may indicate the date of each previous access authorization transfer, and data that identifies the parties involved in the transfer. Therefore, review of the content access metadata 250 of a digital content item by a current or prospective owner would allow that person to see when and how often authorized access in the digital content item has been transferred.

### Previous Owner History

In some embodiments, content access metadata 250 includes history data that indicates information about one or more previous owners of a digital content item or one or more previous access authorization transfers of the digital content item. For example, Jeff purchases a digital book from intermediary 120. Content access metadata 250 of the digital book is created (or updated) to reflect that Jeff owns the digital book. Later, Sally obtains, from Jeff, ownership rights in the digital book, e.g., in exchange for monetary value. In response to the change in ownership, content access metadata 250 of the digital book is updated to indicate that Sally owns the digital book while still indicating that another user (i.e. Jeff) had previously been authorized to access the digital book.

Data that indicates who previously had authorization to access a digital content item may be useful in some situations. For example, a user that purchases a “used” digital biology book may be interested in who previously had access to the digital school book because that previous owner may have helpful information about a class taught by a professor that required that book. As another example, a current owner of a digital movie might be able to see that one or more of her friends also owned that digital movie and, as a result, starts a conversation with them regarding the contents of the digital movie.

In an embodiment, the end-user transferor (e.g., Jeff) has the option to elect not be identified as a previous owner of a digital content item. Thus, in the example above, the content access metadata 250, upon transfer of access authorization, may indicate that another user owned the digital book, but will not (a) identify that Jeff previously owned the digital book or (b) include any information that can be used to identify Jeff as the previous owner of the digital book.

### Location of Content Access Metadata

FIG. 2 illustrates an embodiment in which content access metadata 250 for all digital content items managed by intermediary 120 are stored at intermediary device 220. In an alternative embodiment, content access metadata 250 for each given digital content item is stored with the digital content item, whether the digital content item is on an end-user device (e.g., device 230) that consumes the digital content item, or on intermediary device 220. In other words, content access metadata 250 may be stored wherever the digital content item itself is stored.

Alternatively, content access metadata 250 may be stored separate from its associated digital content item. For example, content access metadata 250 for digital content item 202 that resides on devices 230 and 232 may be stored on device intermediary device 220. Similarly, content access metadata 250 for digital content item 204 that is stored at intermediary device 220 may be stored on devices 230 and 232.

In one embodiment, the digital content item is stored remote to the consuming end-user device, the content access metadata 250 is stored on the end-user device, and the digital content item can only be viewed or experienced if the digital content item is streamed to the end-user device.

### Transfer of Authorized Access

A transfer of authorized access to (or ownership of) a digital content item between entities may or may not actually require the immediate transmission of the digital content item from one computing device to another computing device (for example, over network 200). For example, assume that end-user 130 owns digital content items 202 and 204, illustrated in FIG. 2. Assume further that end-user 130 desires to transfer ownership of digital content item 204 to end-user 140.

In the example shown in FIG. 2, digital content item 204 owned by end-user 130 is stored at a location that is remote to any of the computing devices 230 and 232 operated by end-user 130. In the specific scenario shown in FIG. 2, the location of digital content item 204 is managed and operated by intermediary 120. Thus, in one embodiment, intermediary device 220 stores both the digital content item 204 and the corresponding content access data 250.

When end-user 130 agrees to relinquish his/her authorized access to digital content item 204, digital content item 204 may not be moved from physical storage at all, or at least may not be transmitted from a computing device operated by end-user 130 to another computing device, whether operated by end-user 140 or by intermediary 120.

Instead of transferring an instance of the digital data item 204 to device 240, the content access metadata 250 that indicates that digital content item 204 is owned by end-user 130 may be updated to indicate that (a) end-user 140 is authorized to access digital content item 204, and (b) end-user 130 no longer is authorized to access digital content item 204. Any mechanism for indicating who is authorized (or not) to access the digital content item may be used. Based on the updated content access metadata 250, intermediary 120 prevents end-user 130 from further accessing digital content item 204 after the transfer has been completed. Instead of or in addition to intermediary device 220 updating content access metadata 250 in response to a transfer, content access metadata 250 may be updated by the device of the transferor (e.g., device 230) or by the device of the transferee (e.g., device 240).

### Process Overview

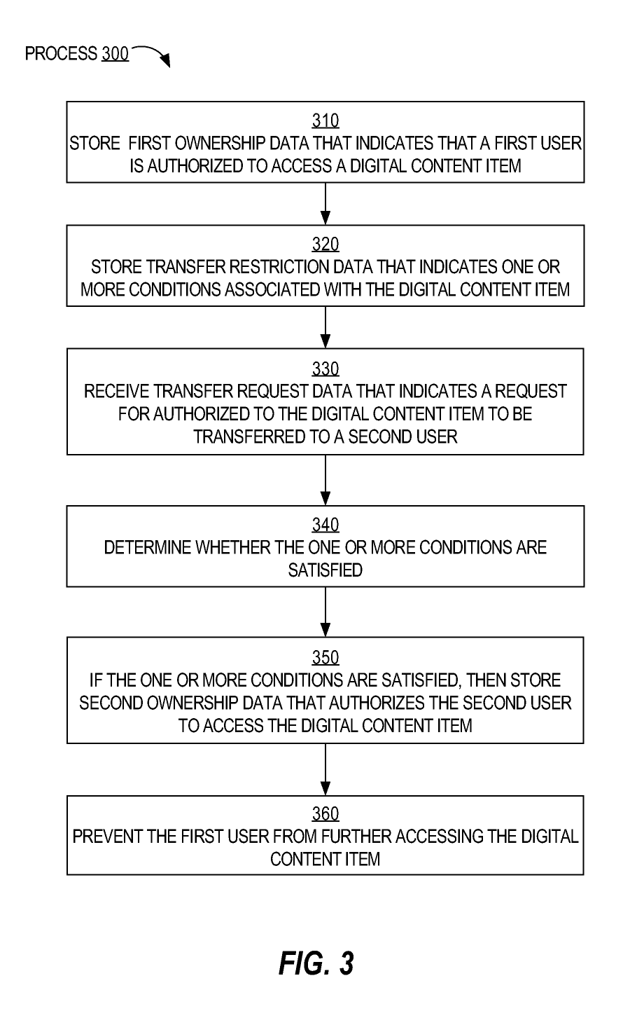

FIG. 3 is a flow diagram that depicts a process 300 for managing access to a digital content item, according to an embodiment of the invention.

At step 310, a particular entity stores first ownership data that indicates that a first user is authorized to access a digital content item, such as digital content item 202. The particular entity may be intermediary device 220, device 230, or device 232. Content access metadata 250 is an example of the first ownership data.

At step 320, the particular entity stores transfer restriction data that indicates one or more conditions that must be satisfied before ownership of the digital content item can be transferred from the first user. A description of the transfer restriction data is provided below.

At step 330, the particular entity receives transfer request data that indicates a request for authorized access to the digital content item to be transferred from the first user to a second user that is different than the first user. The second user is not authorized to access the digital content item prior to the particular entity granting the request. If the particular entity is device 230 or device 232, then the transfer request data may be received from user input. If the particular entity is intermediary device 220, then the transfer request data may be sent, over network 200, from device 230, device 232, or device 240.

At step 340, the particular entity, in response to receiving the transfer request data, determines whether the one or more conditions are satisfied.

At step 350, the particular entity, in response to determining that the one or more conditions are satisfied, stores second ownership data that (a) authorizes the second user to access the digital content item and (b) revokes authorization of the first user to access the digital content item. The second ownership data may be data within content access metadata 250 that is associated with the digital content item.

At step 360, the particular entity, based on the second ownership data, prevents the first user from further accessing the digital content item. As noted below, one example of preventing the first user from accessing a digital content item is to cause each copy of the digital content item on all of the first user's devices (e.g., devices 230 and 232) to be deleted.

### Transfers from the Transferor Device

Instead of or in addition to updating the content access metadata 250, transferring authorized access to a digital content item from end-user 130 to end-user 140 may entail the transmission of the digital content item from a device operated by end-user 130 (e.g., device 230) to a device operated by end-user 140 (e.g., device 240). Similarly, end-user 130 relinquishing authorized access to a digital content item may entail the transmission of the digital content item from a device operated by end-user 130 to a device operated by intermediary 120, unless intermediary 120 already stores a copy of the digital content item.

### User Access Data

In an embodiment, user access data is maintained. “User access data” generally refers to data that indicates, on a per-user basis, one or more digital content items that an end-user (1) owns and/or (2) previously owned and transferred. In one embodiment, as depicted in FIG. 2, intermediary device 220 stores and maintains user access data 260. As shall be described in greater detail hereafter, intermediary 120 may leverage user access data 260 stored at intermediary device 220 to provide offers to the corresponding users.

For example, intermediary device 220 stores user access data 260 that indicates that Jeff sold a digital book (originally purchased by Jeff from intermediary 120) to another user (e.g., Sally). Intermediary 120 uses user access data 260 associated with Jeff to provide, to Jeff, a discount to re-purchase the digital book. This offer may be provided due to a recent promotion of the digital content item (or a related digital content item) or in response to detecting that Jeff is about to purchase the digital book again from intermediary 120.

As another example, Jeff purchases a digital book from intermediary 120, which updates user access data 260 associated with Jeff to reflect the purchase. If the digital book is a book in a series, then intermediary 120 provides Jeff a discount to purchase another digital book in the series.

As another example, Jeff purchases, from intermediary 120, three digital books that are in a series. Intermediary 120 analyzes the user access data associated with Jeff to determine to offer to “buy back” those digital books from Jeff for a discount on or in exchange for another digital content item (e.g., another digital book) or set of digital content items. The discount or exchange may be for a greater value due to the fact that Jeff owns the entire series. Otherwise, the cumulative discount and/or exchange that intermediary 120 would offer separately for each digital book in the series would be less.

In an embodiment, an end-user purchases an entire series (e.g., of books) and any future works in the series at an additional expense. When the future works are completed and released for purchase, those works automatically appear in the end-user's digital library. Also, the end-user may receive additional supplements that the author(s) wish to distribute to such loyal customers. Additional supplements might include short stories, teasers, etc. Instead of a one-time additional expense, this service of receiving additional content may be a monthly or yearly subscription.

### Restricting Access to a Digital Content Item

Any user that purchases a digital content item from intermediary 120 (or directly from publisher 110) has access to the digital content item. For example, intermediary 120 may store a digital movie in association with an account of Jeff in response to Jeff purchasing the digital movie from intermediary 120. When Jeff desires to view the contents of the digital movie, Jeff operates a device (e.g., a laptop computer or a tablet computer) to retrieve (e.g., stream) the digital movie from intermediary 120 to the device. The device transmits, to intermediary device 220, identification data that identifies the digital movie and the user (or device) that seeks access. Intermediary 120 uses the identification data to determine whether Jeff has authorized access to the digital movie. Jeff's device may never store the entire copy of the digital movie; however, Jeff has access to view the digital movie whenever he desires. No other user has authorized access to that copy of the digital movie.

Intermediary 120 may store a single copy of a digital content item that is purchased by multiple users. Thus, intermediary 120 may stream the same copy of a digital movie to all authorized purchasers.

When Jeff and Sally agree to transfer ownership in the digital movie (which transfer does not affect the rights of all other authorized purchases of the digital movie, if any), intermediary 120 stores data (or updates content access metadata 250, described previously) that indicates that only Sally has authorized access to that copy of the digital movie. If Jeff attempts to access any copy of the digital movie after the transfer of ownership has been completed, then he will be denied. For example, when intermediary 120 maintains a digital library that contains references to multiple digital content items that Jeff is authorized to consume. In response to the transfer in ownership of the digital movie, intermediary 120 deletes a reference to the digital movie. Afterward, when intermediary 120 causes the digital library to be displayed to Jeff, the digital library does not contain a reference to the digital movie. Thus, Jeff may not even be able to view a reference to the digital movie unless he (using a computing device) navigates to a “digital store” that offers the digital movie for sale and Jeff purchases the digital movie again.

In the scenario where a copy of a digital content item is stored on a device operated by Jeff, that device may be configured to prevent the user from accessing that copy after authorized access to the digital content item is transferred to another person or entity. For example, in response to detecting that ownership of a digital book has been transferred from Jeff to another individual, the device might delete all copies (if there happens to be more than one) of the digital book from the device's storage. As another example, the device might be configured to simply prevent Jeff from being able to view a reference to the digital book. In this way, while the digital book is still stored on the device, Jeff cannot select the digital book for viewing.

Alternatively, if a device operated by Jeff stores a digital content item and authorized access to the digital content item has been transferred to Sally, but a connection to intermediary 120 is required to control access, then Jeff may have unauthorized access to the digital content item for a period of time. However, once a communication channel (e.g., via the Internet) is established between intermediary 120 and Jeff's device, Jeff's device automatically syncs with intermediary 120. Such a syncing causes Jeff's device to lose actual access to the digital content item. Thus, Jeff's device only has unauthorized access to the transferred digital content item while Jeff's device remains in an “unconnected” state.

In a related example, Jeff owns at least two devices, each of which stores a copy of a digital content item, after which authorized access to the digital content item has been transferred to Sally. At the time of transfer, one of Jeff's devices has an established communication channel to intermediary 120, while the other of Jeff's devices does not have an established communication channel to intermediary 120. Thus, Jeff may not be able to consume the digital content item using the first device, but may still be able to consume the digital content item using the second device while the second device remains in an “unconnected” state.

However, many users will not accept operating their devices in an unconnected state since most devices require access to the Internet in order to gain access to certain data, such as social networks, news, and email. The device may be configured to remind the user that the device has been in an unconnected state for a certain period of time and, optionally, that the user will lose access to one or more digital content items or services if the device is not synced with intermediary 120 within a particular period of time.

### Identifying Potential Transferors and Transferees

There are multiple ways and settings in which potential owners of digital content items can find out what is for sale. For example, Sally may physically meet Jeff on an airplane. Jeff just completed reading a digital book (purchased from intermediary 120) on his tablet computer. Jeff informs Sally that he enjoyed the digital book. Due to Jeff's recommendation, Sally desires to also read the digital book on her tablet computer.

Another way in which Sally can know of Jeff's book (and, possibly, recommendation) is via online resources, such as a social network or a website maintained by intermediary 120. For example, Jeff may post a message on the website, which displays other digital content items that other users wish to sell or give away. Thus, intermediary 120 may facilitate the transfer in ownership of digital content items by acting as a hub to which many users may come to sell or buy “used” digital content items.

As another example, Jeff may post, on his social network account, a message that indicates he enjoyed his digital book. Sally, being a friend/contact of Jeff's in the social network, views the message and contacts Jeff about purchasing the digital book from him. Jeff then notifies intermediary 120 about his digital book and the new prospective owner, Sally, which notification may include a content identifier that identifies the digital book and a transferee identifier that identifies Sally, one of her devices, or one of her accounts (e.g., established and maintained by intermediary 120). Intermediary 120 completes the transfer of ownership by updating content access metadata 250 associated with the digital book to indicate that Sally is the new owner of the digital book. The content access metadata 250 may be further updated to delete any reference to Jeff or to indicate that Jeff was a former owner of the digital book.

As another example, Jeff may identify a contact from a contact list (i.e., accessible on Jeff's device) and send the contact an invitation, which may be in the form of a text (e.g., SMS) message or an email that includes a link to make the purchase.

As another example, Jeff may “bump” his device (e.g., device 230) against Sally's device (e.g., device 240) in order to cause ownership in (or a copy of) a digital content item that is owned by Jeff to be transferred to Sally. A “bump” occurs when two devices make physical contact with each other. The physical contact may be of sufficient force to trigger an action. For example, while device 230 is playing a song and is in a “bump” mode and while device 240 is in a “bump” mode, device 230 touches device 240. This touch or “bump” causes a copy of the song to be accessible to one of Sally's devices (e.g., device 240) either immediately or later.

### Device-to-Device Transfer while Connected to Intermediary

As indicated above, peer-to-peer communication may be used to transfer authorized access to a digital content item from one user to another. In an embodiment, the transfer of ownership includes the transmission of the digital content item from one user's device to another user's device. In the example above where Jeff and Sally meet on an airplane, the actual transmission of the digital book would involve Jeff's tablet computer transmitting the digital book directly to Sally's tablet computer. In order for the transmission to take place, Sally and Jeff enable peer-to-peer communication on their respective devices. Peer-to-peer communication may be implemented by any wireless technology, including, but not limited to, Bluetooth, UWB (ultra-wideband), and ZigBee.

Such device-to-device transfer may be performed while a communication channel is established with intermediary 120. For example, Jeff's device may have a communication channel established with intermediary 120 at the time authorized access to the digital book is transferred to Sally. The device-to-device transfer of the digital content item may be performed before intermediary 120 is notified of the transfer or after intermediary 120 is notified of the transfer. For example, intermediary 120 may be required to be notified of the transfer of ownership in the digital book before the digital book can be transmitted to from Jeff's device to Sally's device. For example, intermediary 120 may determine that authorized access may be transferred after one or more criteria are satisfied, such as whether any restrictions with respect to the digital book, Jeff, and/or Sally would prevent the transfer of authorized access to take place. Such restrictions are described in more detail below.

Once intermediary 120 determines that the transfer can take place, intermediary 120 may send, to Jeff's device, authorization data that indicates that Jeff's device may transfer the digital book to Sally's device.

If authorization data from intermediary 120 is not necessary for the device-to-device transfer of the digital book to occur, then Jeff's device or Sally's device may send, to intermediary 120, a transfer notification that indicates that Jeff's device transmitted the digital book to Sally's device.

### Device-to-Device Transfer while not Connected to Intermediary

In an embodiment, a device-to-device transfer of a digital content item may occur while neither device is connected to intermediary 120. For example, Jeff and Sally may be in a location (e.g., on an airplane) where connectivity to intermediary 120 is not or cannot be established. In such a scenario, after the transfer of ownership occurs, Jeff's device (or software executing on the device) may be configured to prevent Jeff from consuming the digital book. For example, Jeff's device may detect that a transfer of ownership in the digital book occurred and then delete any reference to the digital book from being displayed.

Otherwise, Jeff may have unauthorized access to the digital book, at least until a communication channel is established with intermediary 120. Once the communication channel is established, Jeff's device (or Sally's device) sends, to intermediary 120, transfer data that indicates that authorized access has been transferred from Jeff to Sally. In response, intermediary 120 updates content access metadata 250 associated with the digital book and sends, to Jeff's device, restriction data that causes Jeff's device to prevent the digital book from being display on the device. For example, in response to receiving the restriction data, Jeff's device may delete any local copies of the digital book or not display any references to the digital book. As another example, Jeff may still be able to select a GUI element that references the digital book. However, in response to the selection, Jeff's device determines whether there are any restrictions associated with the digital book, for example, by analyzing the restriction data. If the restrictions indicate that Jeff is not allowed to view the digital book, then Jeff's device will not display the digital book.

Thus, in an embodiment, a transfer of ownership may be “trusted immediately” in that access to a digital content item may be transferred to another without first verifying that the transfer can take place. Later, the transfer may be verified (e.g., by intermediary 120) and, if necessary, revoked (e.g., by intermediary 120).

### Transfer of Ownership without a Device-to-Device Transfer

In an embodiment, direct transmission of a digital content item from a transferor's device to a transferee's device is not performed, even though the two devices may be in close proximity to one another. Instead, the two devices exchange messages that confirm the change in authorized access to the digital content item. Given the example above where Jeff and Sally meet on an airplane, Sally's device may send, to Jeff's device, a message that Sally agrees to obtain ownership in the digital book owned by Jeff. Later, Jeff's device (and/or Sally's device) sends, to intermediary 120, a message indicating that a transfer in ownership of the digital book has taken place or at least that the two parties have agreed to the transfer in ownership. In response, intermediary 120 updates content access metadata 250 associated with the digital book to reflect the change in ownership, which change is used to authorize access to the digital book by Sally and to prevent access to the digital book by Jeff. If Jeff attempts to retrieve and consume the digital book from intermediary 120 after intermediary 120 updates the content access metadata 250, intermediary 120 will check content access metadata 250 associated with the digital book and prevent Jeff from consuming the digital book. Intermediary 120 may prevent Jeff's further consumption of the digital book by sending restriction data (discussed above) to Jeff's device, which uses the restriction data to prevent Jeff from reading the digital book.

In a related example, Jeff's device may send, to Sally's device, an electronic token that indicates that the holder of the token is the one authorized to access the digital book. Later, Sally's device (and/or Jeff's device) sends, to intermediary 120, a message indicating that a transfer in ownership of the digital book has taken place or at least that the two parties have agreed to the transfer in ownership. The message from Sally's device may include the electronic token that establishes Sally as the user that is authorized to access the digital book. In response, intermediary 120 may update content access metadata 250 associated with the digital book to reflect the change in ownership, which change may be used to authorize access to the digital book by Sally and to prevent access to the digital book by Jeff.

### Division of Transfer Proceeds

In an embodiment, authorized access to a digital content item is transferred between Jeff and Sally in exchange for something of value. For example, Sally pays $5 for a digital book that was originally purchased by Jeff from intermediary 120 for $10. In an embodiment, instead of Jeff receiving the entire $5 from Sally, the $5 may be divided between one or two additional parties, such as intermediary 120 and publisher 110 (e.g., if intermediary 120 and publisher 110 are different entities). As an example, of the $5 that Sally pays for the digital book, Jeff may receive $1, intermediary 120 may receive $1 and publisher 110 may receive $3. As another example, Jeff may receive $3, publisher 110 may receive $2, and intermediary 120 receives nothing.

Publisher 110 or intermediary 120 may require that each entity receive a certain percentage of the proceeds of the resale. For example, publisher 110 will receive 25% of the proceeds of the resale of a digital book, intermediary 120 will receive 25% of the proceeds of the resale, and the reseller (e.g., Jeff) will receive 50% of the proceeds of the resale. Alternatively, publisher 110 or intermediary 120 may require that each entity receives a certain amount of the proceeds of the resale. For example, publisher 110 will receive $2 from the proceeds of the resale of a digital movie (e.g., between Jeff and Sally), intermediary 120 will receive $1 from the proceeds of the resale, and the reseller will receive the difference between the resale price and the amount taken by publisher 110 and intermediary 120.

In an embodiment, the percentages that each party or entity receives from a resale of a digital content item changes (1) based on the passage of time or (2) based on how many times the digital content item has been resold among end-users. For example, publisher 110 receives (a) 50% on each resale of digital content item 202 that occurs within a year of the initial sale from intermediary 120 to Jeff and (b) 20% on each resale that occurs more than a year after the initial sale. As another example, publisher 110 receives 50% on the first resale (i.e., from Jeff to Sally) and 40% on second resale (i.e., from Sally to another user, not shown).

Payment may be received by each party in numerous ways. Embodiments of the invention are not limited to any particular payment mechanism. For example, Jeff and Sally may each have a user account established with intermediary 120. Intermediary 120 receives transaction data that indicates Sally agreed to purchase a digital movie from Jeff for $10. In response, intermediary 120 (1) deducts $10 from the account associated with Sally, (2) credits $5 to the account associated with Jeff, (3) credits $3 to an account associated with publisher 110, which originally provided the digital movie to intermediary 120 for sale to end-users, and (4) retains $2 of the $10 for itself.

In the scenario where intermediary 120 and publisher 110 are separate entities, intermediary 120 maintains an account for each publisher that provides, to intermediary 120, digital content items that may be resold by end-users to other end-users. Alternatively, intermediary 120 has access to an account for each such publisher, whether the account is maintained by that publisher or by a third party, such as a bank or other licensed financial institution. In either embodiment, intermediary 120 stores publisher association data that associates, for each of multiple digital content items, the publisher that provided that digital content item to intermediary 120. Thus, when intermediary 120 receives (e.g., from device 230 or device 240) transaction data that identifies a digital content item, intermediary 120 analyzes the publisher association data to determine which publisher provided the digital content item to intermediary 120. In response to identifying the appropriate publisher, intermediary 120 causes funds, from the resale of the digital content item, to be credited to the account of that publisher.

In an embodiment, the transfer of digital content item 202 from Jeff to Sally is made possible by Jeff “gifting” Sally the digital content item. In this embodiment, instead of Sally paying for the transfer in authorized access, Jeff pays. The payment from Jeff for this transfer may be substantially less than the original purchase by Jeff from intermediary 120. Again, the proceeds of Jeff's “gift” may be split between publisher 110 and intermediary 120.

### Limited Editions

In an embodiment, the price a “used” copy of a digital content item increases in response to one or more criteria being satisfied. For example, Jeff purchases digital content item 202 from intermediary 120 for $10. After intermediary 120 has sold all its “new” copies of digital content item 202, the price associated with Jeff's copy increases to $12. The increase in price may be based on demand for digital content item 202 (a) at the time the last “new” copies of digital content item 202 were sold by intermediary 120 or (b) sometime after the last “new” copy of digital content item 202 was sold by intermediary 120. For example, the frequency of “resales” of digital content item 202 among end-users may indicate a certain level of demand.

### Restrictions on Transfer

Digital content item 202 may be subject to one or more restrictions after Jeff purchases digital content item 202 from intermediary 120. For example, digital content item 202 may be restricted regarding to whom authorized access may be transferred, when the transfer may take place, and/or how much must be charged in order for the transfer to take place. The restrictions may be established by publisher 110, intermediary 120, or both. The restrictions may be enforced by software executing on devices operated by intermediary 120 (e.g., intermediary device 220) and/or software executing on devices operated by end-users (e.g., device 230).

The restriction(s) associated with digital content item 202 may be indicated in the content access metadata 250 associated with digital content item 202. Alternatively, the restriction(s) may be stored separate from content access metadata 250 associated with digital content item 202. The data that indicates the one or more restrictions associated with digital content item 202 is referred to herein as “restriction data” and is depicted as restriction data 270 in FIG. 2.

Restriction data 270 may be stored where digital content item 202 is stored, which may be, for example, on (a) device 230 or (b) intermediary device 220. Thus, when ownership in digital content item 202 is transferred, so is restriction data 270 associated with digital content item 202. Alternatively, restriction data 270 of digital content item 202 may be stored on intermediary 220 (as depicted in FIG. 2), regardless of where digital content item 202 is stored.

Before the transfer in ownership of digital content item 202 from Jeff occurs, one or more attributes of the proposed transfer are analyzed against restriction data 270 of digital content item 202 to determine whether the transfer in ownership may occur. Either device 230 or intermediary device 220 may analyze restriction data 270 to make the determination. For example, intermediary device 220 identifies Sally as the potential transferee of digital content item 202 and analyzes restriction data 270 to determine whether there is a restriction that would prohibit the transfer of ownership in digital content item 202 to go to Sally.

Different restrictions may apply to different digital content items, depending on the specific digital content item or the type of digital content item. For example, all digital movies may be subject to one set of restrictions, while all digital books may be subject to a different set of restrictions. As another example, one digital movie provided by publisher 110 may be subject to one set of restrictions that are different than the set of restrictions associated with another digital movie provided by publisher 110.

In an embodiment, the restrictions that apply to a digital content item or a class of digital content items may change over time. For example, one restriction associated with a software application purchased by Jeff from intermediary 120 may be that authorized access to the software application may not be transferred to any other user for the first year after the purchase. Then, after the first year has elapsed, authorized access to the software application may be transferred to any other user. As another example, all digital movies must be sold for a minimum of $10 until six months after their respective original purchase date. After the six month period, all digital movies must be sold for a minimum of $5.

According to an embodiment of the invention, a digital content item that is owned by one user may be copied and provided to multiple users, such as friends of the user or people with whom the user has come into contact. Thus, both the owner and the receiver have access to the digital content item at the same time. However, the digital content item may be copied only a limited number of times, such as one time or three times. Content access metadata associated with the digital content item may indicate the number of times. Further, different digital content items offered for sale by intermediary 120 may be associated with different threshold values. For example, a digital book may be copied two times, while a digital movie may be copied one time.

Additionally, any copies may be restricted from being further copied for other users. For example, content access metadata associated with each copy of the digital content item may indicate that the copy is not to be copied again for other users. As another example, content access metadata associated with each copy of the digital content item may indicate a threshold value that is less than the threshold value indicated for the digital content item owned by the original owner (e.g., Jeff). For example, a digital content item is associated with a threshold value of three, while each copy of the digital content item is associated with a threshold value of one.

### Restrictions on Transfer

### When

In an embodiment, the transfer in authorized access to a digital content item may be restricted with respect to when that transfer may take place. Non-limiting examples of time restrictions include time (or season) of the year, the day of the week, the time of the day, or a period of time since the digital content item was original purchased from intermediary 120. For example, after Jeff purchases a song from intermediary 120, Jeff is not allowed to transfer ownership in the song to another user until four months have elapsed since Jeff's purchase of the song or until a certain date. As another example, after Jeff purchases a digital movie about Christmas from intermediary 120, Jeff is not allowed to transfer ownership in the digital movie to another user during the Christmas season so as to not compromise “new” sales of the digital movie by other users. As another example, after Jeff purchases a digital book about professional football from intermediary 120, Jeff is not allowed to transfer ownership in the digital book to another user between Saturday and Monday during the football season, which is when many users might be interested in purchasing the digital book from intermediary 120.

As noted above, restriction data 270 associated with digital content item 202 may be stored at intermediary device 220 or device 230. To authorize a transfer in ownership from Jeff to Sally, intermediary 220, for example, analyzes restriction data 270 to determine any time restrictions associated with digital content item 202 and then determines whether the time of the proposed transfer in ownership satisfies the time restriction(s). If restriction data 270 associated with digital content item 202 is stored at device 230, then device 230 may send that restriction data to intermediary 220 so that intermediary 220 can analyze the restriction data along with the time of the proposed transfer to determine whether to authorize the transfer. Alternatively, device 230 analyzes restriction data 270 to determine any time restrictions associated with digital content item 202 and then determines whether the time of the proposed transfer in ownership satisfies the time restriction(s).

### Restrictions on Transfer

### How Often

Instead of or in addition to restrictions on the timing of transfers of ownership in digital content items, restrictions may also be established relative to how often ownership in the digital content item may be transferred. For example, ownership in a digital movie may be transferred no more than three times after the initial purchase of the digital movie by Jeff from intermediary 120. After ownership in the digital movie is transferred three times, the last owner of the digital movie is not able to initiate the transfer of ownership in the digital movie again.

As another example, a restriction associated with a digital content item may be the frequency with which ownership in the digital content item may be transferred. For example, ownership in a digital book may be transferred a maximum of three times in a five-month period. Once there is a five-month period in which there were less than three transfers in ownership, ownership in the digital book may be transferred again.

Again, such frequency restrictions are reflected in restriction data 270. In response to detecting that authorized access to digital content item 202 is to be transferred from one user to another, intermediary device 220 (or device 230) analyzes restriction data 270 associated with digital content item 202 to determine whether there are any frequency restrictions. If so, intermediary device 220 analyzes content access metadata 250, which may indicate how often digital content item 202 when and how often digital content item 202 has been transferred. If the proposed transfer and any prior transfers of digital content item 202 do not exceed the frequency restrictions, then intermediary device 220 or device 230 allows the proposed transfer in authorized access to take place (as long as all other necessary conditions regarding the proposed transfer are satisfied).

### Restrictions on Transfer

### To Whom

In an embodiment, authorized access to digital content item 202 may be transferred from one user to virtually anyone. For example, Jeff purchases a digital book from intermediary 120 and then wishes to have authorized access in the digital book transferred to someone else. As long as that other person (which may be any user in the world) has an account with intermediary 120, Jeff may cause ownership in the digital book to be transferred to that other person. Because millions of users may have an account with intermediary 120, the marketplace for “used” digital content items may be very large.

This lack of restriction in the transferee may be reflected in restriction data 270 associated with digital content item 202. For example, restriction data 270 may indicate that the transferee may be anyone. Alternatively, lack of any reference to a transferee restriction in restriction data 270 may indicate that digital content item 202 may be transferred to anyone.

In other embodiments, the transfer in authorized access to digital content item 202 may be restricted with respect to who may be the recipient of that transfer. In other words, the marketplace for “used” digital content items may have one or more significant restrictions. For example, Jeff owns digital content item 202 and may only be able to initiate the transfer in authorized access to other users who are physically located near Jeff, such that the transfer in ownership must be initiated by one or more local communications between device 230 and a device operated by the prospective transferee (e.g., device 240). As noted above, such direct communication between two devices is referred to as peer-to-peer communication. A related restriction is one where devices 230 and 240 are on the same WiFi network.

Thus, in response to detecting a proposed transfer of ownership in digital content item 202, intermediary device 220 (or device 230) analyzes restriction data 270 associated with digital content item 202 to determine whether there are any transferee restrictions and determines that there is a peer-to-peer transferee restriction associated with digital content item 202. Intermediary device 220 (or device 230) then determines whether the device (e.g., device 240) of the proposed transferee (e.g., Sally) has peer-to-peer connection with device 230. If so, then intermediary device 220 (or device 230) authorizes the transfer (as long as all other conditions of the transfer are satisfied).

As another example, authorized access to digital content item 202 may be transferred to only “friends” of Jeff. Such friends may be established in a social network. An association between Jeff and his “friends” may be stored at intermediary device 220 (e.g., in user access data 260) and established by Jeff. Thus, where those friends are physically located is immaterial to whether Jeff can initiate the transfer of authorized access to digital content item 202. For example, Jeff may have 200 “friends” established via one or more social networks (e.g., Facebook, an instant messaging service, or Ping (which is an online social network for music)) and may be allowed to transfer ownership in digital content item 202 to any one of those 200 friends.

Thus, in response to detecting a proposed transfer of ownership in digital content item 202, intermediary device 220 (or device 230) analyzes restriction data 270 associated with digital content item 202 to determine whether there are any transferee restrictions and determines that there is a “friends” restriction associated with digital content item 202. Intermediary device 220 (or device 230) then determines the identity of the proposed transferee (e.g., Sally) and determines whether that identify is found in user access data 260. If so, then intermediary device 220 (or device 230) authorizes the transfer (as long as all other conditions of the transfer are satisfied).

As noted previously, the restriction on the transferee of digital content item 202 may change over time. For example, a digital book may not be transferred from Jeff to any other user until four months after the digital book has been released by publisher 110 so as to not “cannibalize” (or significantly inhibit) new sales of the digital book to other users. After four months, authorized access to Jeff's digital book may only be transferred to another user via peer-to-peer communication. Then, after eight months from the original release date, authorized access to Jeff's digital book may be also transferred to users who are friends of Jeff in a social network. Again, different digital content items provided by publisher 110 may have different restrictions on who can obtain authorized access in the digital content items. The change in restriction on the transferee may involve intermediary 220 updating a “transferee” restriction indicated in restriction data 270 associated with digital content item 202.

### Restrictions on Transfer

### Amount

In an embodiment, an end-user can resell a digital content item for any price. In other words, there is no restriction, from intermediary 120 or publisher 110, on the resale price of a digital content item. In another embodiment, one or more restrictions associated with digital content item 202 may include a minimum amount that must be paid for a transfer in ownership of digital content item 202. For example, Jeff purchases a digital book from intermediary 120 for $10. One restriction associated with the digital book is that the digital book can only be sold to another user (e.g., Sally) for a minimum of $5. Again, an amount restriction associated with digital content item 202 may be reflected in restriction data 270 associated with digital content item 202.

In a related embodiment, the amount restriction associated with digital content item 202 is that intermediary 120 and/or publisher 110 receives a fixed percentage of the resale price until a specific amount is reached. For example, one restriction associated with the digital book above is that the digital book can only be resold if publisher 110 receives 25% of the resale price but no less than $2 from the resale. Thus, if the resale price is $4, then publisher 110 receives $2. If the resale price is $9, then publisher 110 receives $2.25.

In a related embodiment, the minimum price for resale of digital content item 202 varies over time. For example, the minimum resell price of a digital book may be $10 for the first four months after copies of the digital book are released to the public for sale. The minimum resell price of the digital book may be reduced to 6$ after the first four months through the first full year from the original release. After the first full year from the original release, the minimum resell price may be $0.

In an embodiment, the minimum price for a resale of digital content item 202 varies depending on how many other and/or what other digital content items are part of the resale. For example, if a user is attempting to sell a collection of ten songs from a particular artist or album, then the minimum price for the collection may be $5, whereas the minimum price for each one would be $0.90. In a related example, the minimum percentage of the resale proceeds that go to publisher 110 may be 20% for the collection or 30% for each individual song. The collection of digital content items for resale may or may not be of the same type. For example, the collection of digital content items may include one or more digital books, one or more digital movies, and one or more songs.

### Restrictions on Transfer

### Collections

In an embodiment, a restriction associated with digital content item 202 may be that Jeff must own other specific digital content items (e.g., a specific collection) before ownership of digital content item 202 can be transferred to another user. For example, Jeff must own all seven digital books in the Harry Potter series before ownership in any of the digital books in the series can be transferred from Jeff. In a related example, Jeff might only be allowed to transfer ownership in the series as an indivisible unit, rather than being allowed to transfer ownership in each digital book separately from ownership in each other digital book. This “collection” restriction may be reflected in restriction data that is associated with each collection. Thus, in response to detecting that authorized access to digital content item 202 is to be transferred, intermediary device 220 (or device 230) analyzes restriction data 270 associated with digital content item 202 and determines that digital content item 202 is subject to a collection restriction, which may indicate other digital content items in the same collection. In response to this determination, intermediary device 220 determines whether each other digital content item in the collection is owned by Jeff or is part of the proposed transfer. If so, then intermediary device 220 allows the proposed transfer to proceed (as long as all other conditions associated with the proposed transfer are satisfied).

### Restrictions on Consumption

Similarly to restrictions on transfer, restrictions may pertain to the consumption of a digital content item that has been transferred or copied. Such restrictions on consumption of a digital content item may be when and where. For example, Sally may only consume a digital content item (e.g., copied or transferred from Jeff) in a certain location or proximity, such as only on a school campus or at a particular vacation resort. As another example, Sally may only consume a digital content item while Sally's device is connected to a certain network, such as an AT&T network. As another example, Sally may only consume the digital content item while Sally's device (that is consuming the digital content item) is near one of Jeff's devices (e.g., that was used to copy or transfer the digital content item for Sally). This may be useful in games that can only be played with or nearby the original owner or in an educational setting where students can only, for example, watch a movie in the presence of a school teacher (who may be the original owner).

### Value-Added Content

In an embodiment, an owner of a digital content item adds content to (or in association with) the digital content item. For example, Jeff purchases a digital book from intermediary 120 and makes annotations that are stored in association with the digital book. The annotations may be stored in the same file that contains the contents of the book itself, or in a separate file. As another example, an owner of a music track may add a voice introduction or other content to the music track.

The annotations may be in any form, such as text, graphics, audio, and video. The content that is added to digital content item 202 (whether owned by Jeff, Sally, or another end-user) is referred to herein as “value-added content.” Digital content item 202 may be modified to include the value-added content. Additionally or alternatively, the value-added content may be stored separately from digital content item 202. In either scenario, the software executing on device 230 (a) consumes (e.g., displays or plays) the value-added content within digital content item 202 making it appear as if the value-added content is part of the digital content item or (b) provides a mechanism by which the value-added content may be consumed (e.g., displayed or played) via, for example, one or more selectable references.

Intermediary 120 and/or device 230 may store value-added content of digital content item 202. For example, device 230 generates the value-added content (via input initiated by Jeff) and sends the value-added content to intermediary 120, which stores the value-added content in association with digital content item 202 or in association with content access metadata 250 of digital content item 202. As another example, device 230 stores the value-added content and does not send the value-added content to intermediary 120 at any time.

When a transfer of ownership in digital content item 202 that is associated with value-added content occurs, the ownership in the value-added content may or may not also be transferred along with digital content item 202. For example, when authorized access to a digital movie is transferred from Jeff to Sally, Jeff's device (i.e., device 230) may retain the value-added content, send the value-added content directly to Sally's device (i.e., device 240), or send the value-added content to intermediary 120, which might forward the value-added content to Sally's device.

Because of the value-added content, the resale price of digital content item 202 may be more than the original purchase price of digital content item 202 (i.e., that did not include the value-added content) from intermediary 120. This is especially true if a famous or noteworthy individual created the value-added content and, thus, other users are more likely to be interested in viewing that content.

In an embodiment, value-added content is applicable to non-“used” digital content items, or digital content items whose access rights have not been transferred from an original owner. For example, intermediary 120 may offer for sale one or more copies of a “popular” version of a digital content item where an end-user (e.g., Jeff) has added content to his/her copy of the digital content item. Intermediary 120 may need permission from the creator of the value-added content (e.g., Jeff) to sell those copies prior to offering those copies for sale. The “popularity” of a value-added digital content item (or copy) may be defined in many ways, such as the number of users that have owned the value-added copy or at least had access to the value-added copy at one time or another.

As another example, intermediary 120 offers “new” copies of a digital content item that includes “pre-defined” value-added content. Thus, intermediary 120 does not need to rely on buyers or end-users of a digital content item to provide value-added content. For example, Jon Stewart provides, to intermediary 120, comments on a complimentary copy of a politician's autobiography.

In an embodiment, a digital content item (whether “used” or “new”) is associated with value-added content from multiple sources. For example, Jeff adds content to digital content item 202, then transfers ownership to Sally who then adds content to digital content item 202. When Sally transfers ownership in digital content item to another user, Jeff's content and Sally's content are also transferred to the other user. As another example, multiple well-known sports commentators review a book about a popular sports figure and add content to various paragraphs in the book. Intermediary 120 sells the book along with the commentators' content to the general public.

In an embodiment, value-added content associated with a digital content item is “added” (or made available) to an owner of a digital content item “on-the-fly.” In other words, value-added content associated with a digital content item does not have be part of the digital content item at the time of sale. For example, Jeff purchases a digital book from intermediary 120. The digital book is not associated with any value-added content. Later, value-added content, generated by one or more other users (who may or may not own their own copies of the digital book) are made available to Jeff. Value-added content may be made available to Jeff (or Sally, if Sally owns a “used” copy of the digital book) in multiple ways. For example, the value-added content may be sent, from device(s) that generated the value-added content, to intermediary 220 and stored, at intermediary 220, in association with digital content item 202 (i.e., the digital book in this example). Later, Jeff causes the value-added content to be downloaded from intermediary 220 to device 230. Alternatively, the device(s) that generated the value-added content may send the value-added content to device 230 (either over a network or directly) without first (or ever) sending the value-added content to intermediary 220.

In this embodiment, value-added content may be added to a digital content item continuously. In this way, an instant community of users can be created around the digital content item. For example, a digital book may become very popular and owners of copies of the digital book provide value-added content in the form of reviews, comments, critiques, alternate endings, etc. regarding the digital book to each other (e.g., via intermediary 220). For example, intermediary 220 collects value-added content regarding digital content item 202 from multiple users that own a copy of digital content item and stores the value-added content in association with digital content item 202. Intermediary 220 allows each owner of a copy of digital content item 202 to access the value-added content, which may be “pushed” by intermediary 220 to one or more devices of each owner (i.e., without requiring each owner to request the value-added content) or may be (e.g., selectively) “pulled” (or requested) by one or more devices of each owner.

The ability to “add” value-added content to a digital content item that is owned by an end-user may be purchased by the end-user. For example, Jeff owns a digital game (purchased from intermediary 120), but is unable to add content (including, for example, tips from other players, reviews, etc.) to the digital game without making a payment to intermediary 120 (or another party). Once Jeff makes the payment, he can receive (e.g., at device 230) value-added content that is generated by one or more other people, regardless of whether they own the digital game.

In an embodiment, annotations associated with different copies of a particular digital content item may be viewed when owners of the different copies of the particular digital content item are in close proximity. For example, each person in a book club owns a copy of a digital book and, while discussing the book in close physical proximity, any annotations made by each person are made viewable by other people in the same room or area. The close proximity may be determined, for example, based on whether each device operated by each person in the book club is on the same Wi-Fi network. Then, when a particular book club member leaves and is no longer in physical proximity to other members in the book club, that particular member will not be able to see the annotations of other members in the book club concerning the digital book. A similar example is in a class setting where each student (or class member) is able to view annotations by the teacher and/or other students while class is in session or while the student's device is in close physical proximity to the teacher's device and/or other students' devices.

### Temporary Transfers

In an embodiment, the transfer of authorized access to digital content item 202 is temporary. Such a transfer may be considered a “loan” of digital content item 202. For example, Jeff purchases a digital book from intermediary 120 and then agrees to have authorized access to the digital book transferred to Sally for a period of time, such as two days. Jeff's device or Sally's device sends, to intermediary device 220, temporary transfer data that indicates that Sally has authorized access to the digital book for two days. In response to receiving the temporary transfer data, intermediary device 220 may update content access metadata 250 associated with the digital book to indicate that Sally is authorized to access the digital book for two days and that Jeff is not allowed to access the digital book for those two days. If Jeff's device (i.e., device 230) stores a local copy of the digital book, then Jeff's device may prevent Jeff from viewing the digital book on that device (as described previously). During that period of time, while Sally has authorized access to the digital book, Jeff does not. After the period of two days has elapsed, authorized access to the digital book is automatically reverted back to Jeff, for example, by intermediary device 220 updating content access metadata 250 associated with the digital book to indicate that Jeff is authorized to access the digital book and Sally is not. Jeff is then able to consume the digital book.

As another example, both Jeff and Sally are able to access the digital book during the two day period of time. In other words, both Jeff and Sally have authorized access to the digital book. Intermediary device 220 may update content access metadata 250 of the digital book to reflect that both Jeff and Sally have authorized access to the digital book. However, after the two day period of time, only Jeff has authorized access to the digital book while Sally is unable to do so. Thus, intermediary device 220 may update the content access metadata 250 to remove Sally as one who has authorized access to the digital book.

In an embodiment, a temporary transfer may be restricted to a portion of digital content item 202, instead of authorized access to the entire digital content item being transferred. For example, authorized access to the first chapter of a digital book may be transferred (e.g., for free) from Jeff to Sally for a period of time. If Sally enjoys the first chapter, then Sally may be more likely to purchase her own copy of the digital book from intermediary 120 or purchase the entirety of the digital book from Jeff.

In an embodiment, a temporary transfer is only possible if Sally (or Jeff) pays for the temporary transfer. For example, Sally may pay $1 to intermediary 120 for authorized access to a digital book purchased by Jeff. A portion or the entirety of the $1 may be provided to publisher 110. Additionally or alternatively, Jeff may also receive a portion of the $1.

In a related embodiment, the price of a temporary transfer depends on which portion of digital content item 202 is subject to the authorized access being transferred, how much of digital content item 202 is subject to the authorized access being transferred, how long the temporary transfer may last, and/or whether the transferor also has authorized access, during the time period of the temporary transfer, to digital content item 202 that is subject to the temporary transfer. For example, Jeff may be allowed (e.g., as dictated by publisher 110) to temporarily transfer, to Sally, authorized access to the first chapter of a digital book for free. Jeff may also be allowed (e.g., as dictated by publisher 110) to temporarily transfer, to Sally, authorized access to the next three chapters of the digital book for another $2. Additionally or alternatively, Jeff may be allowed (e.g., as dictated by publisher 110) to temporarily transfer, to Sally, authorized access to the first three chapters of the digital book for $2.

Content access metadata 250 associated with digital content item 202 may indicate whether digital content item 202, or a portion thereof, may be temporarily transferred. Thus, before intermediary device 220 (or device 230) authorizes a temporary transfer of digital content item 202, intermediary device 220 (or device 230) analyzes content access metadata 250 associated with digital content item 202 to determine whether digital content item 202 is allowed to be temporarily transferred. If the proposed temporary transfer is for a portion (i.e., less than all) of digital content item 202, then intermediary device 220 (device 230) analyzes content access metadata 250 to determine whether the portion indicated in the proposed temporary transfer is the same or less than the portion indicated in content access metadata 250. If so, then the proposed temporary transfer may take place (as long as all other conditions of the proposed temporary transfer are satisfied).

As indicated above, the criteria that causes a temporary transfer to end is time (e.g., two days). However, one or more other criteria may be used in determining when to end a temporary transfer by denying access to the transferee (e.g., Sally) and re-granting access to the transferor (e.g., Jeff). Non-limiting examples of such one or more other criteria is the affirmative revocation by the transferor, the occurrence of an external event, or the proximity of the devices (e.g., devices 230 and 240) used by the transferor and the transferee. For example, Jeff transfers, to Sally, access to a digital book for an indefinite period of time. Jeff may “revoke” Sally's access rights and obtain sole access to the digital book whenever Jeff chooses. The revocation of Sally's access rights may be initiated by Jeff through a device (e.g., device 230) that notifies intermediary device 220 of Jeff's intention to revoke Sally's access rights to the digital book, which was previously owned by Jeff. In response, intermediary device 220 updates content access metadata 250 to reflect the revocation. As another example, Sally has access rights to the digital book until a movie version of the book comes out in theatres. As another example, Sally has access rights to the digital book as long as Sally's device (e.g., device 240) is within a certain distance from Jeff's device (e.g., device 230) or is on the same Wi-Fi network as Jeff's device. Later, Sally may be provided the option (via intermediary 120) to purchase the digital book from intermediary 120, for example, at a discounted price. As another example, a teacher could purchase numerous copies of a novel and temporarily transfer the copies to students (or, rather, devices of the students') in one of the teacher's class. The copies on the students' devices are deleted when the students leave the classroom or in response to a command from the teacher (e.g., via one of the teacher's devices). In this way, students would not be required to purchase their own copies and the teacher can share a variety of digital works inexpensively.

In a related embodiment, a temporary transfer ends when the transferor (e.g., Jeff) of digital content item 202 requests digital content item 202 from the transferee (e.g., Sally), and the transferee agrees to the revocation. Thus, there is no time restriction or external event that must occur in order for the temporary transfer to end. Also, the transferor cannot unilaterally end the temporary transfer. Instead, both the transferor and the transferee must signal their respective intentions (e.g., to each other's devices and/or to intermediary 220) that the temporary transfer is to end. In an embodiment, in this scenario, the revocation of access rights in a digital content item from the transferee and the return of those access rights to the transferor may occur without any indication, at the time of the original transfer, that the original transfer was going to be temporary. Instead, the parties (e.g., Jeff and Sally) may have originally intended that the original transfer to be permanent, but later, the parties agree to have the access rights returned to the original transferor (e.g., Jeff). Thus, a “permanent” transfer later becomes a temporary transfer. In order to change the permanent nature of the original transfer to a temporary one may or may not require permission (and/or payment) from intermediary 120 or publisher 110.

### Delayed Transfers

In an embodiment, after Jeff and Sally agree to a transfer of authorized access to digital content item 202, Jeff still has access to digital content item 202. This is referred to as a “delayed transfer.” For example, Jeff and Sally agree that ownership of a digital book owned by Jeff will be transferred to Sally. However, during the first two days after the agreement, Jeff still has authorized access to the digital book. The delayed transfer may allow Jeff to finish reading the digital book if he has not already done so. Also, during the first two days after the agreement, Sally may or may not have access to the digital book. Thus, Jeff and Sally may or may not both be able to read the digital book at the same time during those first two days. After the first two days after the agreement, Jeff no longer has access to the digital book. Instead, Sally has sole authorized access to the digital book.

Delay transfer data that indicates whether digital content item 202 can be delay transferred may be indicated in content access metadata 250 associated with digital content item 202. Before intermediary device 220 (or device 230) authorizes a delayed transfer of digital content item 202, intermediary device 220 (or device 230) analyzes the delay transfer data associated with digital content item 202 to determine whether digital content item 202 is allowed to be delay transferred. If so, then the proposed delay transfer may take place (as long as all other conditions of the proposed delay transfer are satisfied).

Alternatively, no check of the delay transfer data is made prior to the transfer of ownership of digital content item 202 from Jeff to Sally. Instead, intermediary device 220 (or device 230) does not perform any step that would prevent Jeff from accessing digital content item 202. For example, device 230 does not delete a local copy of digital content item 202 that is stored on device 230, at least until the time period associated with the delay transfer elapses. As another example, intermediary device 220 does not store data that indicates that Jeff is not allowed to access digital content item 202, at least until the time period associated with the delay transfer elapses.

In an embodiment, the actual transfer in ownership is made upon the original owner completely consuming the digital content item. For example, Jeff and Sally agree that a digital movie Jeff owns will be transferred to Sally. However, the transfer in ownership is not performed until Jeff finishes watching the digital movie. Jeff's device (e.g., device 230) or intermediary device 220 determines when Jeff (or rather Jeff's device) displays the entire the digital movie and Jeff turns off his device. At that point, Jeff's device or intermediary device 220 updates content access metadata associated with the digital movie to indicate that Sally now has sole access to the digital movie and that Jeff no longer has access rights thereto.

### Partial Transfers

In an embodiment, instead of transferring ownership in the entirety of digital content item 202, Jeff may cause the transfer in ownership of less than the entirely of digital content item 202 and retain ownership in the remainder. Such a transfer is referred to as a “partial transfer.” For example, Jeff purchases a digital movie from intermediary 120, where the digital movie includes a “behind-the-scenes” portion. Instead of transferring ownership in the entire movie to Sally, authorized access to only the “behind-the-scenes” portion is transferred to Sally. After the transfer, only Sally has access to the “behind-the-scenes” portion.

As another example, Jeff purchases a digital book from intermediary 120. Jeff reads the first three chapters of the digital book. Prior to finishing the digital book, which includes ten chapters, Jeff transfers ownership in the first three chapters to Sally, who then has access to those chapters and can begin reading those chapters without being able to access the other seven chapters. Meanwhile, Jeff still has authorized access to the remaining seven chapters but no longer has access to the first three chapters. Later, authorized access to the remaining seven chapters may be transferred to Sally. This transfer may be triggered by input from Jeff or by the lapse of a predetermined period of time, similar to a delayed transfer, discussed above.

The partial transfer of digital content item 202 may be reflected in content access metadata 250 of digital content item 202. In the digital book example above, intermediary 120 (and/or Jeff's device) updates content access metadata 250 of the digital book to indicate that Sally has authorized access to the first three chapters and that Jeff has authorized access to the last seven chapters. Intermediary device 220 may send, to Jeff's device, partial restriction data that indicates which portion of the digital book Jeff is no longer authorized to access. Jeff's device, in response to receiving the partial restriction data, may simply delete that portion (e.g., the first three chapters) or prevent the display of that portion if Jeff ever attempts to read that portion. With respect to Sally, intermediary device 220 may send only the first three chapters to Sally's device. Alternatively, intermediary device 2120 may send the entire digital book along with partial restriction data that indicates which portion (e.g., the last seven chapters) that Sally is not authorized to view. Sally's device analyzes the partial restriction data and, in response, prevents the display of that portion if Sally ever attempts to read that portion.

Such “partial transfers” may be useful in situations where publisher 110 (or intermediary 120) desires users to provide “sneak-peaks” to other “peered” users (i.e., users whose devices must communicate directly with the owner's device) or to “friends,” who may be “friends” or “contacts” of the owner in a social network. Thus, in an embodiment, publisher 110 (or intermediary 120) provides restrictions on which portion of a digital content item may be partially transferred, i.e., transferred without transferring the entire digital content item. Intermediary device 220 and/or device 230 are configured to enforce those restrictions.

As another example, in the value-added content scenario described previously, Jeff purchases a digital book from intermediary 120 and then annotates the digital book with his own content. Jeff may agree to have authorized access to the value-added content transferred to Sally, but Jeff retains authorized access to the digital book. Conversely, ownership of the digital book is transferred from Jeff to Sally but Jeff retains ownership of the value-added content.

### Modifying Digital Content Items Upon Transfer

In an embodiment, in response to a transfer in ownership of digital content item 202, digital content item 202 is modified in some way to reflect the fact that digital content item 202 has undergone an ownership transfer. The change may be visual and/or audible. For example, the visual appearance of digital content item 202 may be altered, in response to resale of digital content item 202, to make it appear that digital content item 202 is “used.”

For example, in response to Jeff transferring ownership in a digital book to Sally, the digital book is modified so that the digital pages of the digital book, when viewed by Sally, appear worn (for example, with folded corners or with bent edges), similar to a physical book that has been used. As another example, a song may be modified by reducing the sampling rate and/or adding pops or clicks or other commons sounds produced by a record player that plays an old vinyl record.

Alternatively, instead of modifying digital content item 202, the “used” aspect may be reflected in metadata that is associated with digital content item 202. Thus, Sally's device (i.e. device 240) may be configured to analyze the metadata to determine the appearance of “pages” of the digital book. The metadata may include an “age” parameter that is used by Sally's device to determine how much the appearance of the “pages” of the digital book should be modified. The “age” parameter may be incremented in response to a transfer in ownership of the digital book. The value of the age parameter may reflect the number of years or period of time since the original purchase of the digital book from intermediary 120. For example, if the first authorized transfer of the digital book is within the first year of the original purchase from intermediary 120, then the “age” parameter may be ‘1’ on a scale of 0 to 10, ‘0’ indicating brand new and ‘10’ indicating the most used. However, if the first authorized transfer of the digital book is after five years from the original purchase from intermediary 120, then the “age” parameter may be ‘4’. The value of the age parameter may reflect how often the digital book (or portions thereof) has been read. Thus, if the digital book has only been read once and the first authorized transfer of the digital book is 10 years after the original purchase, then the “age” parameter may be ‘2’, whereas if the digital book has been read five times and the first authorized transfer of the digital book is 1 year after the original purchase, then the “age” parameter may be ‘6.’

Alternatively, instead of Sally's device analyzing the metadata to determine how to display the digital book, intermediary device 220 analyzes the metadata and determines how to display the digital book. In this scenario, intermediary device 220 sends a modified version of the digital book (e.g., based on the “age” parameter) to Sally's device.

In an embodiment, this “used” feature may be turned on and off by the new owner of digital content item 202. Thus, for example, Sally may choose, by the selection of one or more graphical options displayed on her device, to view the digital book with or without worn pages.

In an embodiment, a user pays intermediary 120 to cause a “used” digital content item appear new. For example, Sally pays intermediary 120 to have the digital book appear new on Sally's device. If Sally pays, then intermediary device 220 may reset the “age” parameter associated with the digital book to ‘0.’

### Updating Editions/Versions

In an embodiment, the owner of a digital content item is prompted to update his/her digital content item with the latest edition or version of the digital content item. This prompt may be from intermediary device 220 or a device operated by publisher 110. For example, intermediary 220 determines that (a) Jeff owns the 6^{th} edition of a digital book on discrete mathematics and (b) a 7^{th} edition of that digital book is available. This determination may be made by analyzing user access data 260. In response, intermediary device 220 sends, to device 230, offer data that indicates that Jeff may purchase the 7^{th} edition for a discounted price (e.g., 35% off or $40 off the original price). In a related example, intermediary device 220 may determine that Sally purchased the 6^{th} edition from Jeff. Consequently, intermediary device 220 may send Sally the notice that the 7^{th} edition is available.

In an embodiment, whether the current owner of a digital content item is the “original owner” affects the discount. For example, if Sally purchased a 4^{th} edition digital book from intermediary 120, then intermediary 120 would offer, to Sally, 25% off the purchase price of the 5^{th} edition. If Sally purchased the 4^{th} edition from another user (e.g., Jeff), then intermediary 120 would offer 10% off the purchase price of the 5^{th} edition.

In one embodiment, at the time of an upgrade offer to the current owner of a digital content item, intermediary 120 indicates to the current owner how much (used purchase price+upgrade amount) would save the current owner relative to someone directly buying the latest edition. For example, Sally purchases the 4^{th} edition of a digital book for $5 from Jeff, who purchased the 4^{th} edition for $10 from intermediary 120. Intermediary 220 stores data about each purchase. Intermediary 120 then provides an offer for Sally to purchase the 5^{th} edition for only $4, which edition is normally sold for $12. Thus, intermediary 120 may notify Sally (e.g., by intermediary device 220 sending savings data to device 240) that she would save $3 ($12—($5+$4)) by accepting the offer.

### Non-Transfer Scenarios

Because intermediary device 220 stores information about Jeff and about the digital content item(s) that Jeff owns (e.g., in user access data 260), intermediary 120 may leverage such information to benefit Jeff (and/or users associated with Jeff) in numerous ways.

### Non-Transfer Scenario

### Owner as Advertiser

Instead of transferring ownership in digital content item 202, Jeff may be the source by which other users learn about digital content item 202. Those other users then purchase their own copies of digital content item 202 from intermediary 120 without Jeff relinquishing his authorized access to digital content item 202. The other users may inform intermediary 120 that they learned of digital content item 202 from Jeff. The other users may inform intermediary 120 through, for example, an account number associated with Jeff or other data that otherwise identifies Jeff and that intermediary device 220 recognizes. In one embodiment, the other users each receive a discount when purchasing digital content item 202 due to their relationship with Jeff.

In an embodiment, Jeff receives, from intermediary 120, something of value in return for his role in the other users' purchase of the digital content item. For example, Jeff may receive a discount (e.g., 25% off) that may be used to reduce the purchase price of another digital content item from intermediary 120. As another example, Jeff may receive store “points” that may be used to purchase another digital content item once Jeff earns enough points. As yet another example, Jeff may receive a credit to a credit/debit card account.

### Non-Transfer Scenario

### Regret Feature

In some situations, an owner of a digital content item decides that authorized access to the digital content item is not worth what the owner originally paid for the digital content item. For example, Jeff purchases a digital book from intermediary 120 and, two days later, without having read the book, decides that he is no longer interested in reading the book. In one embodiment, a user that purchases a digital content item may (1) relinquish, to the original seller, his/her access to the digital content item and (2) receive a credit or discount on another digital content item if one or more criteria are satisfied.

The one or more criteria may be based on time, such as the period of time from the user's purchase of the digital content item to the present or the period of time from when the user first began to consume the digital content item to the present. For example, credit for relinquishing ownership may be available to Jeff only if Jeff has owned digital content item 202 for less than a predetermined period of time. As another example, there may be no hard limit to when Jeff may relinquish ownership for credit, but the amount of credit he will receive may be based on how long Jeff has owned digital content item 202. Thus, relinquishing ownership of digital content item 202 soon after it was purchased from intermediary 120 may result in a 90% credit, while relinquishing ownership after several years may result in a 1% credit.

Additionally or alternatively, the one or more criteria used by intermediary device 220 to determine whether ownership of a digital content item may be relinquished for credit, and if so, how much credit, is based on usage data that indicates how much a digital content item has been consumed by the current owner. For example, if the usage data associated with digital content item 202 indicates that Jeff's device (e.g., device 230) has consumed more than a specified amount of digital content item 202, then a credit or discount might not be available, or may be for a reduced amount.

Intermediary device 220 (or device 230) may store usage data in association with content access metadata 250 of digital content item 202. If intermediary device 220 streams digital content item 202 (e.g., a digital movie) to Jeff's device (e.g., device 230), then intermediary device 220 updates usage data to reflect how much of digital content item 202 has been viewed. Similarly, if intermediary device 220 sends one “page” of a digital book for each page request received from Jeff's device, then intermediary device 220 updates usage data to indicate how many pages (or how much content) have been sent to Jeff's device. Additionally or alternatively, Jeff's device maintains usage data in association with digital content item 202 and the usage data indicates how much of digital content item 202 has been consumed by Jeff. For example, Jeff's device keeps track of how many “pages” of a digital book have been displayed (or how much of a digital movie has been played) by the Jeff's device. Jeff's device later sends usage data of digital content item 202 to intermediary device 220, which uses the usage data to determine how much of a credit or discount to offer Jeff for digital content item 202.

Continuing with the digital book example, Jeff has only read 5% of the digital book, which may be less than a specified threshold amount (e.g., 20%). Jeff then attempts to obtain credit from intermediary 120 or obtain a discount from intermediary 120 on one or more other digital content items offered by intermediary 120 for sale. For example, intermediary 120 offers Jeff a 50% discount off the purchase price of any other digital content item for sale. As another example, intermediary 120 offers a credit of 25% to Jeff's credit/debit card account.

The threshold usage amount of a digital content item may be established by publisher 110 or intermediary 120. A threshold usage amount may be established on a digital content item-by-digital content item basis. Thus, different digital books may be associated with different threshold usage amounts. Alternatively, a threshold usage amount may be established based on the different types of digital content items. For example, digital books may be associated with a threshold usage amount of 5%, digital movies may be associated with a threshold usage amount of 10%, and digital music may be associated with a threshold usage amount of 8%.

In a related embodiment, a digital content item may be associated with multiple threshold usage amounts, or an owner may be receive value for relinquishing ownership of a digital content item on a pro rata basis. Thus, even if Jeff has consumed most of the digital book, a credit or discount may still be available for Jeff. For example, if the usage data associated with the digital book indicates that Jeff has not read 10% of the digital book, then Jeff may receive a 10% credit from intermediary 120. Similarly, if Jeff has not viewed 1% of the digital movie, then Jeff may receive, from intermediary 120, a 1% discount for another digital movie (purchased from intermediary 120).

### Non-Transfer Scenario

### Roles and Multi-User Access Rights

In an embodiment, a user that purchases a digital content item is associated with a role that is used to determine a set of users that are also authorized to access the digital content item. For example, Jeff has established an account with intermediary 120 and has the role of head of a family in relation to that account. Jeff has also established, with intermediary 120, that three other users are members of Jeff's family. Because of Jeff's role and relationship to those other users, those users are also authorized to access any digital content items owned by Jeff.

In an embodiment, a user's role is associated with only certain digital content items. Thus, each digital content item owned by a user is associated with zero roles, one role, or more roles, regardless of the number of roles associated with the user. In other words, family members of Jeff may be authorized to access only certain digital content items owned by Jeff.

A role associated with digital content item 202 may be established at the time of purchase of digital content item 202 by Jeff or some time after the purchase of digital content item 202 by Jeff. For example, Jeff purchases a digital movie from intermediary 120 under the role of head of family. Intermediary 120 verifies whether Jeff is allowed to purchase the digital movie under that role. In response to the verification, intermediary 120 identifies, based on the role, the other users that are also authorized to access the digital movie.

As another example, Jeff purchases a digital movie from intermediary 120 under no role. Jeff later requests intermediary 120 to cause the digital movie to be associated with his role as head of a family to enable other members of his family to have authorized access to the digital movie. Such a request may be granted if certain conditions are satisfied, such as a further payment from Jeff to associate the digital movie with that role.

In a related embodiment, instead of authorized access to the entirety of digital content item 202 owned by Jeff, the other users that are considered part of Jeff's family may have to purchase authorized access to digital content item 202. However, the price at which those other users have to pay may be less than what other (i.e., non-family member) users would have to pay. For example, family members of Jeff may purchase authorized access to a digital movie owned by Jeff for $4 while users unaffiliated with Jeff would have to pay $8 for the digital movie.

Different users may have many different roles other than family. Further, a single user may be associated with multiple roles. For example, Jeff may have the role of teacher and 30 other users may have the role of students of that teacher. Thus, when Jeff obtains authorized access to a digital book, Jeff desires to have his teacher role associated with that digital book, which allows his 30 students to obtain authorized access to the digital book for free or for a discounted price.

Whatever the role, intermediary device 220 stores user role data that associates, for each user of one or more users, one or more roles. For example, Jeff may have the role of member of Smith family and professor of Biology class 312 at Henry Community College. User role data is used to verify whether digital content item 202 may be associated with a particular role, depending on the owner (or prospective owner) of digital content item 202. Content access metadata 250 of digital content item 202 may be updated to reflect the role associated with the owner of digital content item 202.

Intermediary device 220 also stores role relationship data that associates, for each role of a user, one or more other users that have a relationship with that user under that role. Role relationship data is used to identify the other users that are associated with a role that is associated with a digital content item.

In an embodiment, intermediary device 220 may use the user role data to determine the price at which a particular user may purchase a digital content item. For example, if Jeff purchases a digital movie without respect to any role, then the digital movie might cost $10. However, if Jeff purchases the digital movie under his family role, then the digital movie might cost $13 since other users (i.e., in his family) would also have authorized access to the digital movie.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

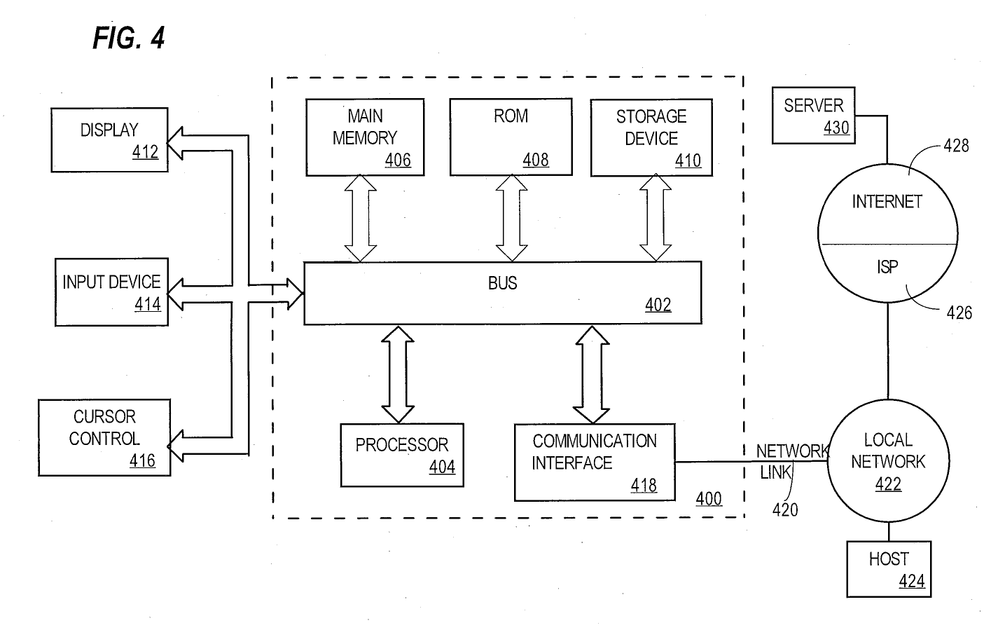

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method for managing access to digital content items, the method comprising:
storing first ownership data that indicates that a first user is authorized to access a digital content item;
storing transfer restriction data that indicates one or more conditions that must be satisfied before ownership of the digital content item can be transferred from the first user;
receiving, at a particular entity, transfer request data that indicates a request for authorized access to the digital content item to be transferred from the first user to a second user that is different than the first user, wherein the second user is not authorized to access the digital content item prior to the particular entity granting the request;
in response to receiving the transfer request data, the particular entity determining whether the one or more conditions are satisfied;
in response to determining that the one or more conditions are satisfied, storing second ownership data that (a) authorizes the second user to access the digital content item and (b) revokes authorization of the first user to access the digital content item; and
based on the second ownership data, the particular entity preventing the first user from further accessing the digital content item;
wherein the method is performed by one or more computing devices.

2. The method of claim 1, wherein:
a device is not in communication with the particular entity at the time the first user transferred the authorization to the second user; and
the particular entity receives the transfer request data from the device in response to a connection between the device and the particular entity being reestablished.

3. The method of claim 1, wherein the first ownership data indicates one or more of (a) time data that indicates when the digital content item was purchased, (b) price data that indicates a price at which the digital content item was purchased, or (c) device data that indicates a device to which the digital content item is to be transmitted.

4. The method of claim 1, further comprising, after storing the second ownership data, storing data that tracks who previously owned the digital content item.

5. The method of claim 1, wherein:
the first user transferred the authorization to the second user in exchange for an amount of money from the second user;
the method further comprising causing a portion of said amount to be transferred to an account of a publisher that provided the digital content item to the particular entity.

6. The method of claim 5, further comprising causing a second portion of said amount to be transferred to an account of the particular entity.

7. The method of claim 1, wherein the one or more conditions include a condition that the digital content item can only be transferred from the first user to the second user if a device operated by the first user is in peer-to-peer communication with a device operated by the second user.

8. The method of claim 1, wherein:
the one or more conditions include a condition that the second user has a particular relationship with the first user; and
storing the second ownership data is performed only in response to determining that the second user has the particular relationship with the first user.

9. The method of claim 8, wherein the particular relationship is one of the second user is a friend of the first user in a social network or the second user belongs to a group to which the first user belongs.

10. The method of claim 1, wherein:
the one or more conditions include a condition that the transfer is made during a particular time period; and
determining whether one or more conditions are satisfied includes determining that the transfer is made during the particular time period.

11. The method of claim 10, wherein the particular time period is a fixed duration window that begins at the initial purchase of the digital content item.

12. The method of claim 1, wherein:
the one or more conditions include a condition that the transfer is made for at least a minimum amount of money;
determining whether one or more conditions are satisfied includes determining that the transfer is made for at least the minimum amount of money.

13. The method of claim 1, wherein:
the one or more conditions include a condition that the authorization to access one or more other specific digital content items, to which the first user has authorized access, is also being transferred to the second user;
determining whether one or more conditions are satisfied includes determining that the authorization to access one or more other specific digital content items, to which the first user has authorized access, is also being transferred to the second user.

14. The method of claim 1, further comprising:
receiving annotation data that reflects annotations that the first user made relative to the digital content item;
storing the annotation data in association with the digital content item; and
after determining that the one or more conditions are satisfied, sending the digital content item and the annotation data to a device operated by the second user.

15. The method of claim 1, further comprising:
after receiving the transfer request data and prior to storing the second ownership data, storing access data that indicates that the first user is allowed to access the digital content item for a particular amount of time;
wherein storing the second ownership data is performed in response to the lapse of the particular amount of time.

16. The method of claim 15, further comprising, after receiving the transfer request data and prior to storing the second ownership data, storing second access data that indicates that the second user is allowed to access the digital content item.

17. The method of claim 1, wherein:
the digital content item is a first version of the digital content item;
the method further comprising:
sending, to a device operated by the second user, a message that offers, to the second user, a second version of the digital content item that is newer than the first version;
receiving, from the device, a response that indicates that the second user wishes to obtain authorized access to the second version.

18. The method of claim 17, wherein:
sending the message comprises determining a price at which to offer the second version; and
the price is based on whether the second user is the first person to own the digital content item.

19. A method for managing access to digital content items, the method comprising:
storing transfer restriction data that indicates one or more conditions that must be satisfied before a first user is allowed to transfer ownership of a digital content item;
receiving, at a device used by the first user to consume the digital content item, first input that indicates a request for authorized access to the digital content item to be transferred from the first user to a second user that is different than the first user, wherein the second user is not authorized to access the digital content item prior to the device receiving the first input;
in response to receiving the first input, the device determining whether one or more conditions are satisfied;
wherein the one or more conditions are conditions, specified in the transfer restriction data, that govern transfer of the digital content item;
in response to determining that the one or more conditions are satisfied, storing ownership data that (a) indicates that authorized access to the digital content item has been transferred to the second user, and (b) revokes authorization of the first user to access the digital content item; and
based on the ownership data, the device preventing the first user from using the first device to consume the digital content item;
wherein the method is performed by one or more computing devices.

20. A method comprising:
storing, at a particular entity, first data that authorizes a first user to access a digital content item;
receiving, at the particular entity, second data that indicates a request for authorized access to the digital content item to be transferred from the first user to a second user that is different than the first user, wherein the second user is not authorized to access the digital content item prior to the particular entity granting the request;
in response to receiving the second data, the particular entity storing third data that authorizes the second user to access the digital content item;
after storing the third data, the particular entity tracking how much time has elapsed since the second user was authorized to access the digital content item;
in response to the particular entity determining that the amount of elapsed time exceeds a particular threshold, the particular entity storing fourth data that revokes authorization of the second user to access the digital content item; and
based on the fourth data, the particular entity preventing the second user from further accessing the digital content item;
wherein the method is performed by one or more computing devices.

21. The method of claim 20, wherein:
storing the third data comprises storing fifth data that revokes authorization of the first user to access the digital content item; and
storing the fourth data comprises storing sixth data that authorizes the first user to access the digital content item.

22. A method comprising:
storing, at the particular entity, first data that authorizes a first user to access a digital content item;
receiving, at the particular entity, second data that indicates a request for authorized access to a first portion of the digital content item to be transferred from the first user to a second user that is different than the first user, wherein the second user is not authorized to access the first portion of the digital content item prior to the particular entity granting the request, wherein the portion is less than all of the digital content item;
in response to receiving the second data, the particular entity storing third data that (a) authorizes the second user to access the first portion of the digital content item and (b) revokes authorization of the first user to access the first portion of the digital content item;
after storing the third data, the particular entity allowing the first user to access a second portion of the digital content item, wherein the second portion is different than the first portion; and
based on the third data, the particular entity preventing the first user from further accessing the first portion of the digital content item;
wherein the method is performed by one or more computing devices.

23. A method comprising:
storing ownership data that indicates whether a current owner of a digital content item is the initial purchaser of the digital content item;
based on the ownership data, performing at least one of:
displaying a visual representation of the digital item whose appearance is based, at least in part, on whether the current owner is the initial purchaser of the digital content item; or
causing the digital content item to sound audibly different based, at least in part, on whether the current owner is the initial purchaser of the digital item;
wherein the method is performed by one or more computing devices.

24. The method of claim 23 wherein:
storing ownership data includes storing transfer history data that indicates how frequently ownership of the data content item has been transferred; and
the step of performing includes performing at least one of:
displaying a visual representation of the digital content item whose appearance is based, at least in part, on how frequently ownership of the data content item has been transferred; or
causing the digital content item to sound audibly different based, at least in part, on how frequently ownership of the data content item has been transferred.

25. The method of claim 23, wherein:
the digital content item is a digital book;
the method further comprising, based on the ownership data, displaying a visual representation of the digital item whose appearance is based, at least in part, on whether the current owner is the initial purchaser of the digital content item.

26. The method of claim 23, wherein:
the digital content item is a digital audio item;
the method further comprising, based on the ownership data, causing the digital content item to sound audibly different based, at least in part, on whether the current owner is the initial purchaser of the digital item.

27. One or more non-transitory storage media storing instructions which, when executed by one or more processors, cause performance of the method recited in claim 1.

28. One or more non-transitory storage media storing instructions which, when executed by one or more processors, cause performance of the method recited in claim 19.

29. One or more non-transitory storage media storing instructions which, when executed by one or more processors, cause performance of the method recited in claim 20.

30. One or more non-transitory storage media storing instructions which, when executed by one or more processors, cause performance of the method recited in claim 22.

31. One or more non-transitory storage media storing instructions which, when executed by one or more processors, cause performance of the method recited in claim 23.
